(19) United States
(12) Patent Application Publication
(10) Pub. No.: US 2010/0253971 A1
(43) Pub. Date: Oct. 7, 2010

(54) Image forming apparatus, image processing terminal and image forming system formed including the same

(75) Inventors: Kazuhiko Ido, Osaka (JP); Hidetomo Nishiyama, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/661,632

(22) Filed: Mar. 19, 2010

(30) Foreign Application Priority Data
Apr. 2, 2009 (JP) 2009-089715

(51) Int. Cl. G06F 15/00

(52) U.S. Cl. 358/1.15

(57) ABSTRACT

A control unit of an image forming apparatus executes a program including the steps of: calculating a hash value based on image data received from an image processing terminal; if the same image has already been printed by a user of the same group, giving a notice to that effect to the user who requested printing; if request to continue printing is nevertheless issued, printing the image data; updating hash log information of itself if the same image has not been printed; and establishing synchronization of hash log information with other image forming apparatus or apparatuses.

### BACKGROUND OF THE INVENTION

This nonprovisional application claims priority under 35 U.S.C. §119(a) on Patent Application 2009-089715 filed in Japan on Apr. 2, 2009, the entire contents of which are hereby incorporated by reference.

### FIELD OF THE INVENTION

The present invention relates to an image forming system for printing an image formed by an image processing terminal (such as a personal computer) by an image forming apparatus (such as an MFP (MultiFunctional Peripheral) or a printer) through a network and, more specifically, to an image forming system that can effectively prevent accumulative printing of the same image. The present invention also relates to an image forming apparatus and an image processing terminal forming such an image forming system.

### DESCRIPTION OF THE BACKGROUND ART

Recently, a print service is available by which a print request is issued to a network service and printing can be done by an arbitrary image forming apparatus (printer) connected to the network. More specifically, by the print service, when printing is to be done from an image processing terminal such as a personal computer (hereinafter denoted as a “PC”), image data is once stored in a server computer and a print request is made from any of a plurality of image forming apparatuses connected to the network, whereby printing can be done from any of the image forming apparatuses.

In such a print service, considering image memory capacity of a shared server computer or from security concerns, the image data printed upon request from the image forming apparatus is deleted from the server computer.

Among such print systems printing images using a network, a print system that avoids a wasteful printing when printing of a shared file on the network is requested and the printing has already been done is disclosed in Japanese Patent Laying-Open No. 2003-208289 (Document 1), and a log information management system that generates and manages log information for monitoring unauthorized image formation is disclosed in Japanese Patent Laying-Open No. 2007-079902 (Document 2).

The print system disclosed in Document 1 includes: log management means, when printing of a shared file on a network is executed by an instruction from any of a plurality of computers connected to a shared printer through the network, for storing the file name and print-related information in association with each other; searching means, when printing of a shared file is instructed by a computer, for searching whether or not the file already exists in the log management means; and notifying means, when the file already exists in the log management means, for notifying the computer that issued the print instruction of the corresponding print-related information.

By the print system, if there is a history that a shared file of which printing is instructed by a user has been printed in the past by the user himself/herself or any other user, print-related information thereof can be known. In such a case, execution of printing is suspended, and based on the searched out print-related information (name of the computer that instructed printing in the past, print setting conditions, printing medium, date and time of printing, date and time of file update, and position where the printer that executed the printer belongs), the printout can be obtained. As a result, wasteful printing can be avoided.

The log information management system disclosed in Document 2 includes: image processing means for performing a process on data of an image; image data generating means for generating image data from data of the image; unique number generating means for generating a unique number corresponding to the image data generated by the image data generating means; job information generating means for monitoring process status of the image processing means and for generating job information; log information generating means for generating log information including job information, image data and the unique number; log information storage means for storing the log information; determining means for determining, every time the unique number generating means generates a unique number, whether or not the same unique number exists in the log information stored in the log information storage means; and log information changing means for deleting image data from the log information generated by the log information generating means if the determination by the determining means is positive. The log information storage means is characterized in that when the log information with the image data deleted is stored, it is related to log information having the same unique number as the unique number included in the subject log information.

According to the log information management system, every time a unique number is generated by the unique number generating means, whether the same unique number as the generated unique number exists in the log information storage means is determined by the determining means.

If the same unique number exists, the image data is deleted from the generated log information by the log information changing means, and the resulting log information is stored in correspondence with the unique number stored in the log information storage means. This prevents storage of image data derived from the same image in the log information storage means, and hence, storage capacity for the log information in the storage means can be saved.

### SUMMARY OF THE INVENTION

The log information management system disclosed in Document 2, however, is simply to prevent repeated registration (storage) of image data that has already been registered (stored) using a hash value, in order to enable efficient use of a memory storing the image data. Therefore, when there is a print request for the same image data, printing process takes place. This means that even if a user belonging to a same group (for example, same division or section of a corporate office) has already completed a printing process, repeated printing is accepted. Thus, it follows that printing is done even if printing is actually unnecessary, wasting the running cost of the image forming apparatus and the cost of recording paper.

The print system disclosed in Document 1 is focused on such a waste. However, the server computer must transmit the transmitted shared file name and the print-related information to all printers installed for the computer that instructed printing. Therefore, in this print system, a server computer is an indispensable component. Therefore, to a print system not including a server computer having such a function, this technique is not applicable. Specifically, by a simple configuration including only the client computers and a plurality of printers of the print system disclosed in Document 1, it is impossible to prevent accumulative printing of the same image.

Further, in the print system, each printer searches whether the same file name as the file of which printing is instructed already exists in its log management unit. However, if the shared files for the same document are stored in one folder, search by file name possibly fails, as the file name is often not unique. It is possible that the same document of a different file name is printed. It is highly likely that, even if the file of interest is a shared file, the same image data of the same file name exist in different folders. Therefore, the print system that utilizes different file names cannot avoid accumulative printing of the same document.

Further, the print system is on the premise that all printers on the network are operating (communicable with the power ON). Therefore, if a printer that stores in its log management unit a log that a certain document was printed is not operating and other operating printers do not store such a log, it follows that the same document is printed by other operating printer.

It is noted that a technique referred to as “job log” for storing print job history in a general image forming apparatus has been known. Though this technique allows storage of user name, date and time of printing, file name and the like, it is impossible to determine only from the file name if the image data is the same.

Therefore, an object of the present invention is to provide an image forming system that effectively and reliably avoids accumulative printing of the same image by individual image forming apparatus without requiring a server computer, when image data is transmitted from an image processing terminal such as a personal computer through a network to an image forming apparatus on the network and printing is executed by the image forming apparatus, as well as to provide an image forming apparatus and an image processing terminal forming such an image forming system.

According to an aspect, the present invention provides an image forming apparatus used in an image forming system in which an image data to be printed from an image processing terminal is transmitted to and printed by any of a plurality of image forming apparatuses connected by a network. The image forming apparatus includes: a receiving unit receiving, from the image processing terminal, the image data and user information identifying a user who requested printing of the image data; a generating unit generating identification data enabling unique identification of the image data, based on the received image data; a printing unit printing an image based on the image data; a storage unit storing, when the image is printed, the identification data corresponding to the printed image in association with the user information; a notifying unit providing the image processing terminal with alarm information for outputting an alarm on the image processing terminal, if the identification data corresponding to the image data received from the image processing terminal has been stored in the storage unit; a transmitting unit transiting synchronization data including the identification information and the user information stored in the storage unit to an image forming apparatus connected to the network; and a control unit controlling the storage unit such that when the synchronization data is received from the image forming apparatus, the image data and the user information included in the synchronization data are stored in association with each other. Here, the alarm information may indicate that the image has already been printed based on the received image data by any of the plurality of image forming apparatuses.

If the same image has already been printed by any of the image forming apparatuses connected by the network, the image forming apparatus notifies the fact to the user who requested printing. Specifically, alarm information outputting an alarm that the image has already printed by any of the plurality of image forming apparatuses is transmitted by the image forming apparatus to the image processing terminal. Receiving such an alarm, the user may become aware of the waste and refrain from printing, since it may be sufficient to refer to the previously provided print-out if the purpose is just a rough confirmation of printed image (color, tone and overall balance). By such an approach, it is possible to effectively prevent accumulative printing of the same images in an image forming system by which images are printed by a large number of users. Thus, wasteful printing can be prevented. Further, such a process can be executed by a configuration including image forming apparatuses only (not including a server computer) on the network. This is because synchronized image data and user information are stored in a plurality of image forming apparatuses. By way of example, when an image is printed by one image forming apparatus, synchronization data is transmitted (simultaneously broadcast) to the image forming apparatuses connected to the network. Receiving the synchronization data, the image forming apparatus stores the image data and the user information included in the received synchronization data, in its storage unit. Therefore, by a configuration including image forming apparatuses only not including a server computer (image processing terminal is necessary), accumulative printing of the same image data can be effectively prevented, and waste can be reduced. As a result, an image forming apparatus forming an image forming system that effectively and reliably avoids accumulative printing of the same image by individual image forming apparatus without requiring a server computer, when printing is executed by the image forming apparatus, can be provided.

The image forming apparatus may further include a group storage unit for storing a group to which the user belongs. Here, the notifying unit may issue the alarm information to the image processing terminal, if the identification data is stored in the storage unit and printing has been already done by a user of the same group.

If the same image has already been printed by a user belonging to the same group, the image forming apparatus notifies the fact to the user who requested printing. Receiving such a notice, the user may become aware of the waste and refrain from printing, since it may be sufficient to refer to the user nearby for the previously provided print-out if the purpose is just a rough confirmation of the printed image. It is often the case that the user belonging to the same group stays nearby and, hence, there is a good chance that the printed image is readily available for reference. By such an approach, it is possible to effectively prevent accumulative printing of the same images by the user of the same group in an image forming system by which images are printed by a large number of users. Thus, wasteful printing can be prevented.

In the image forming apparatus, the transmitting unit may transmit a difference newly stored in the storage unit when the image is printed, as the synchronization data, to the image forming apparatus.

The image forming apparatus transmits not all the identification data and the user information stored in the storage unit as synchronization data to other image forming apparatuses (possibly including itself) but only the difference to other image forming apparatuses. This prevents significant increase of communication traffic on the network.

The image forming apparatus may further include: a determining unit determining whether or not data stored in the storage unit is synchronized with data stored in other image forming apparatus; and an obtaining unit obtaining data to be stored in the storage unit depending on the determination by the determining unit.

In the image forming apparatus, if the data (identification data and user information) stored in the storage unit is not synchronized with the data stored in other image forming apparatuses (for example, if the data of itself is old), the data to be stored in the storage unit is obtained by the obtaining unit. Therefore, the data (identification data and user information) stored in storage units of a plurality of image forming apparatuses connected to the network can reliably be synchronized.

In the image forming apparatus, the obtaining unit may obtain the data to be stored in the storage unit from other image forming apparatus, if it is determined that data stored in the storage unit is older than and not synchronized with data stored in the other image forming apparatus.

In the image forming apparatus, if the data stored in the storage unit is not synchronized with the data of other image forming apparatus or apparatuses and the data of itself is old, the data to be stored in the storage unit is obtained by the obtaining unit from other image forming apparatus. Therefore, the data stored in storage units of a plurality of image forming apparatuses connected to the network can reliably be synchronized.

In the image forming apparatus, the obtaining unit requests other image forming apparatus for a difference between the data stored in the storage unit and data stored in the storage unit of the other image forming apparatus, and obtains the difference from the other image forming apparatus.

In the image forming apparatus, as regards the data obtained by the obtaining unit from other image forming apparatus, not all of the identification data and the user information stored in the storage unit of the other image forming apparatus but only the difference is requested as the synchronization data from the other image forming apparatus. Therefore, data synchronization can be attained without significantly increasing the communication traffic on the network. Further, a server computer is unnecessary.

The image forming apparatus may further include a difference transmitting unit transmitting the difference to other image forming apparatus when the difference is requested by the other image forming apparatus.

If the data (identification data and user information) stored in the storage unit of itself is new, difference is requested from other image forming apparatus. Receiving such a request, the image forming apparatus transmits the difference to other image forming apparatus. Therefore, data synchronization can be attained without significantly increasing the communication traffic on the network. Further, a server computer is unnecessary.

The image forming apparatus may further include an erasing unit, erasing the identification data and the user information stored in the storage unit, based either on elapsed time from printing or stored data capacity.

In the image forming apparatus, an upper limit of elapsed time from printing is set, and when the upper limit is reached, the identification data and the user information may be deleted from the older ones, or an upper limit of data amount is set, and when the upper limit is reached, the identification data and the user information may be deleted from the older ones. Such an approach eliminates the necessity of increasing the capacity of hash log information storage unit.

In the image forming apparatus, the generation unit may generate the identification data from the image data, using a one-way function. Here, the one-way function may be a hash function.

Since hash function, which is a one-way function, is used, it is possible to determine whether the image data is the same, even after the original image data is deleted. Further, from the hash value calculated by the one-way function, the original image data cannot be estimated and, hence, when the original image data is deleted, security is ensured. The data to be printed is identified using not the file name but the one-way function. Therefore, whether the image data is the same or not can reliably be determined.

According to another aspect, the present invention provides an image processing terminal used in an image forming system in which an image data to be printed from an image processing terminal is transmitted to and printed by any of a plurality of image forming apparatuses connected by a network. The image processing terminal includes: a transmitting unit transmitting, to the image forming apparatus, the image data and user information identifying a user who requested printing of the image data; a receiving unit receiving alarm information transmitted from the image forming apparatus if it is determined, based on data synchronized among the plurality of image forming apparatuses, that an image corresponding to image data transmitted from the image processing terminal has already been printed by any of the plurality of image forming apparatuses; and an output unit outputting the alarm information.

In the image processing terminal, an alarm that the image has already been printed by any of the plurality of image forming apparatuses is output (for example, displayed on a monitor). Receiving such an alarm, the user may become aware of the waste and refrain from printing, since it may be sufficient to refer to the previously provided print-out if the purpose is just a rough confirmation of printed image (color, tone and overall balance). By such an approach, it is possible to effectively prevent accumulative printing of the same images in an image forming system by which images are printed by a large number of users. Thus, wasteful printing can be prevented.

In the image processing terminal, the alarm information indicates that printing has already been done by a user belonging to a group same as the user who requested printing of the image data, by any of the image forming apparatuses.

If the same image has already been printed by a user belonging to the same group, the image processing terminal notifies the fact to the user who requested printing. Receiving such a notice, the user may become aware of the waste and refrain from printing, since it may be sufficient to refer to the user nearby for the previously provided print-out if the purpose is just a rough confirmation of the printed image.

The image processing terminal may further include: a setting unit setting that output of the alarm information is unnecessary, in correspondence with the user and identification data; and a continuation request transmitting unit transmitting, if an object of the alarm information satisfies set conditions, a request to continue printing to the image forming apparatus without outputting the alarm information.

If it is necessary to repeatedly output the same image (for example, to output monthly ledger), repeated display of the alarm can be avoided. Further, since the print continuing request is transmitted to the image forming apparatus, it is possible for the user to print the image without knowing such an alarm and without inputting the request to continue printing. Such a function may be realized by deleting the data (identification data and user information) stored in the storage unit of the image forming apparatus. It is advantageous, however, to set conditions for not outputting the alarm information in the image processing terminal, since processes of maintaining and synchronizing data stored in image forming apparatuses become unnecessary.

According to a further aspect, the present invention provides an image forming system including a plurality of above-described image forming apparatuses and at least one image processing terminal, and does not require any server computer.

By the present invention, in an image forming system in which image data is transmitted from an image processing terminal through a network to any of image forming apparatuses connected to the network and printing is executed, accumulative printing of the same image by individual image forming apparatus can effectively and reliably be avoided without requiring a server computer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of the image forming system in accordance with a first embodiment of the present invention.

FIG. 2 is a functional block diagram showing hardware configuration of an image forming apparatus 100 shown in FIG. 1.

FIG. 3 is a functional block diagram showing hardware configuration of an image processing terminal 200 shown in FIG. 1.

FIG. 4 shows a user information storage table stored in a user information storage unit 154 shown in FIG. 2.

FIG. 5 shows a hash log storage table stored in a hash log information storage unit 156 shown in FIG. 2.

FIG. 6 is a flowchart representing a control structure of a program executed by a control unit 110 of image forming apparatus 100 shown in FIG. 2.

FIG. 7 shows a structure of synchronization data communicated between image forming apparatuses.

FIG. 8 is a flowchart representing a control structure of a program executed by a control unit 210 of image processing terminal 200 shown in FIG. 3.

FIG. 9 shows an exemplary image displayed on a display unit 230 of image processing terminal 200 shown in FIG. 3.

FIG. 10 is a flowchart representing a control structure of a synchronization program in the image forming system in accordance with a second embodiment of the present invention.

FIGS. 11 and 12 show structures of latest generation number data communicated between image forming apparatuses.

FIG. 13 shows a structure of difference data of hash log information communicated between image forming apparatuses.

FIG. 14 is a functional block diagram showing hardware configuration of image processing terminal 200 forming the image forming system in accordance with a third embodiment of the present invention.

FIG. 15 shows an alarm invalidating storage table stored in a display invalidating list storage unit 252 shown in FIG. 14.

FIG. 16 is a flowchart representing a control structure of a program executed by a control unit 210 of image processing terminal 200 shown in FIG. 14.

FIG. 17 shows an exemplary image displayed on a display unit 230 of image processing terminal 200 shown in FIG. 3.

### DESCRIPTION OF THE PREFERRED EMBODIMENTS

In the embodiments below, the same components are denoted by the same reference characters. Their functions and names are also the same. Therefore, detailed description thereof will not be repeated. In the following, a print service system (image forming system) including an image processing terminal (PC) by which a user forms or edits image data and an electro-photographic image forming apparatus (printer) for printing the image data on a paper medium will be described. The present invention, however, is not limited to the above, and it is applicable to any print service system that includes an image processing terminal and an image forming apparatus on a network (not necessarily including a server computer). As can be readily understood from the fact that the image forming apparatus prints information including characters, the concept of “image” involves characters.

### First Embodiment

### [Overall System Configuration]

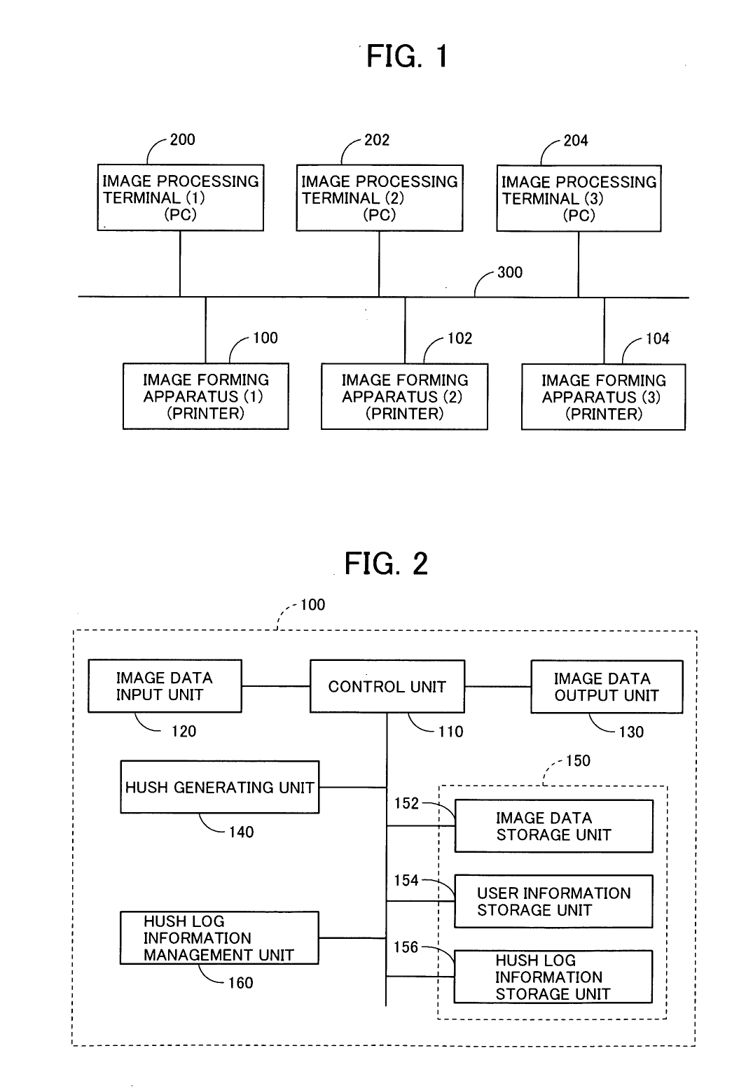

FIG. 1 shows an overall configuration of a print service system including an image processing terminal (PC) and an image forming apparatus (printer).

As shown in FIG. 1, the print service system includes: an image processing terminal (1) 200, an image processing terminal (2) 202 and an image processing terminal (3) 204 each implemented, for example, by a PC (hereinafter referred to as an “image processing terminal 200”); an image forming apparatus (1) 100, an image forming apparatus (2) 102 and an image forming apparatus (3) 104 (hereinafter referred to as an “image forming apparatus 100”) for forming an image on a sheet of recording paper by, for example, electro-photographic printing method; and an LAN (Local Area Network) line 300 for network-connection of these apparatuses. The number of image processing terminals 200 and the number of image forming apparatuses 100 are each not limited to three. What is necessary is that the system includes at least two image forming apparatuses 100 and at least one image processing terminal 200.

Image forming apparatus 100 realizing the characteristic function of the present invention determines, in response to a print request from image processing terminal 200, whether or not the image, of which printing is requested, has already been printed by any image forming apparatus 100, based on print history (hash log information) stored in image forming apparatus 100. If the image has already been printed and the user who printed the image by any of the image forming apparatuses and the user who requested printing belong to the same group, the fact that the image has been printed is notified to the user who requested printing. If the user who requested printing still requests to continue printing, printing process is executed by image forming apparatus 100. In order to realize such a function, image forming apparatus 100 also has a function of synchronizing hash log information of each other so that it can store the latest hash log information.

### [Hardware Block]

FIG. 2 is a functional block diagram showing hardware configuration of image forming apparatus 100. As shown in FIG. 2, image forming apparatus 100 includes: an image data input unit 120 connected to LAN line 300 and to which image data from image processing terminal 200 is input (received); an image data output unit 130 from which image data is output (printed); a hash generating unit 140 calculating a hash value from the image data; a storage unit 150; a hash log management unit 160 managing the hash log; and a control unit 110 controlling image forming apparatus 100.

Control unit 110 is formed of a CPU (Central Processing Unit) and a memory storing variables or programs to be executed by the CPU. Specifically, the memory includes an ROM (Read Only Memory) for storing programs and the like, and an RAM (Random Access Memory) providing a memory area when a program is executed.

The ROM stores programs and data necessary for controlling operations of image forming apparatus 100. The CPU executes control related to each function of image forming apparatus 100 in accordance with the programs and data stored in the ROM.

Among the functions of image forming apparatus 100, image forming apparatus 100 executes a process for avoiding accumulative output (printing) of the same image data, as will be described later. In parallel with such programs, the CPU executes programs realizing general functions of the image forming apparatus (printer), in order to control image forming apparatus 100. The programs, however, are not directly related to the essential characteristics of the present invention and, therefore, details thereof will not be described in the embodiment.

Hash generating unit 140 generates a hash value that is calculated by a one-way function (hash function), from the image data received from image processing terminal 200. The hashfunction may include “SHA-1”and “MD5”, and hash generating unit 140 generates the hash value from the image data using such a hash function. Since the hash function is a one-way function, it is impossible to estimate the original image data from the generated hash value. The hash value represents unique data for each image data, and has far smaller capacity than the original image.

Storage unit 150 may be implemented by a flash memory or an HDD (Hard Disk Drive), which is a non-volatile storage area capable of storing data and the like even when power of image forming apparatus 100 is turned off. The RAM provides a function of a working memory for temporarily storing results of operations and processes by the CPU, and it may also provide a function of a frame memory for temporarily storing image data.

More specifically, storage unit 150 includes: an image data storage unit 152 storing image data itself; a user information storage unit 154 storing user information related to the user of the print service system; and a hash log information storage unit 156 storing a hash log including the hash value generated by hash generating unit 140.

hash log management unit 160 has a function of synchronizing the hash log information stored in hash log information storage unit 156 such that the plurality of image forming apparatuses 100 store the same hash log information. Hash log management unit 160 may be implemented by hardware or implemented by software through a program executed by control unit 110. In the following, the hash log information synchronizing process will be described as implemented by a program executed by control unit 110.

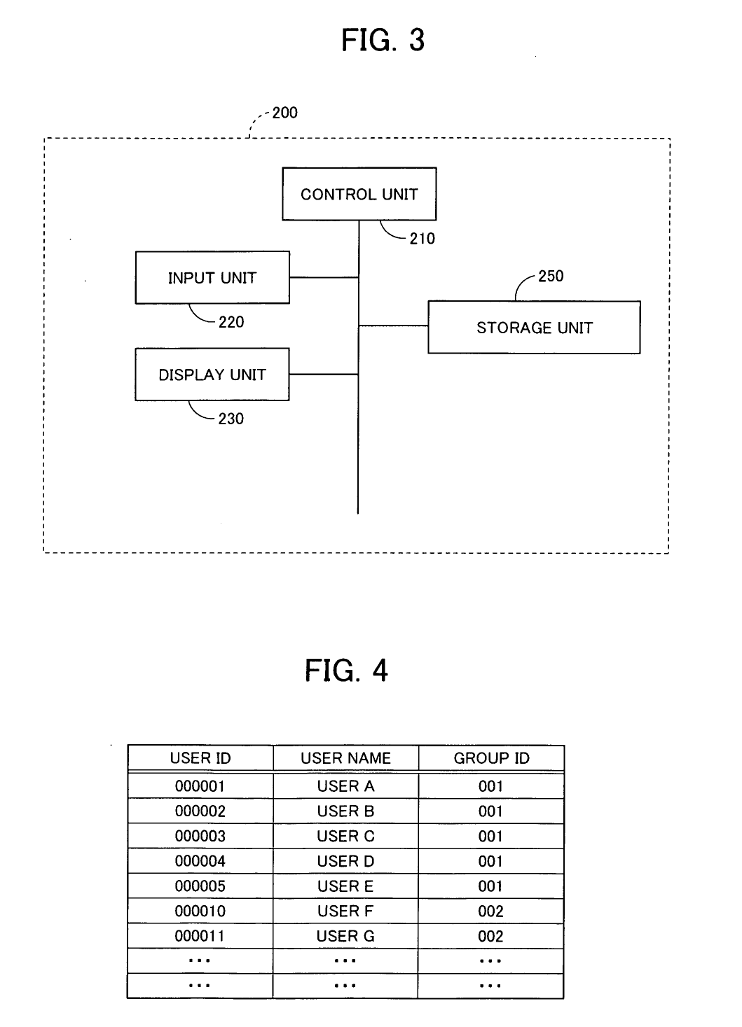

FIG. 3 is a functional block diagram showing hardware configuration of image processing terminal 200. As shown in FIG. 3, image processing terminal 200 has the same configuration as a general PC. It includes: an input unit 220 such as a keyboard or a mouse; a display unit 230 implemented by a monitor or the like for presenting visual information to the user; a storage 250; and a control unit 210 controlling image processing terminal 200.

Similar to control unit 110 described above, control unit 210 is formed of a CPU (Central Processing Unit) and a memory storing programs or variables to be executed by the CPU. More specifically, the memory includes an ROM for storing programs and the like, and an RAM providing a memory area when a program is executed.

The ROM stores programs and data necessary for controlling operations of image processing terminal 200. The CPU controls various functions of image processing terminal 200 in accordance with programs and data stored in the ROM.

Among the functions of image processing terminal 200, image processing terminal 200 executes a process for outputting alarm information to the user, in order to avoid accumulative output (printing) of the same image data, as will be described later. In parallel with such programs, the CPU executes programs realizing general functions of a computer, in order to control image processing terminal 200. The programs, however, are not directly related to the essential characteristics of the present invention and, therefore, details thereof will not be described in the embodiment.

In the functional block diagram of image forming apparatus 100 shown in FIG. 2 and the functional block diagram of image processing terminal 200 shown in FIG. 3, the network communication unit is not depicted.

Referring to FIG. 4, the user information stored in user information storage unit 154 will be described. As shown in FIG. 4, the user information is stored in a user information storage table formed of at least a field for storing the user name and a field for storing a group ID to which the user belongs, with a user ID used as a key. Here, the group ID is a group identifier provided for each business operation unit, such as a division or section of a company. It is assumed that users belonging to the same business operation unit are seated close to each other.

As shown in FIG. 4, user ID “000001” indicates that the user name is “User A” and the group ID is “001”, user ID “000002” indicates that the user name is “User B” and the group ID is “001”, and user ID “000010” indicates that the user name is “User F” and the group ID is “002”. Thus, when two user IDs are known, it is possible to determine whether the users belong to the same group or different groups.

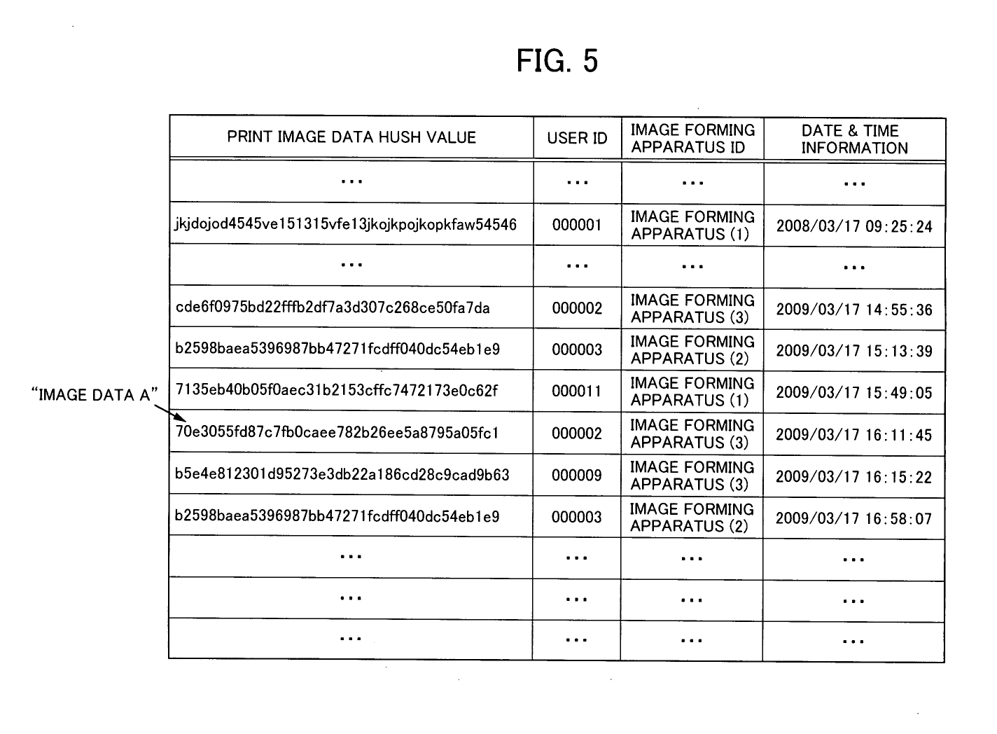

Referring to FIG. 5, the hash log information stored in hash log information storage unit 156 will be described. As shown in FIG. 5, the hash log information is stored in a hash log storage table including a field for storing a user ID of the user who printed the image data identified by a print image data hash value as a key, a field for storing an image forming apparatus ID of the apparatus that printed the image data, and a field for storing date and time information of the date and time when the image data was printed, with the print image data hash value used as a key. Here, the user ID is an identifier for identifying a user who requested printing of the image data corresponding to the hash value, and it corresponds to the user ID shown in FIG. 4. The Image forming apparatus ID is an identifier for uniquely identifying an image forming apparatus 100 included in the print system, and it may be a device name or an IP address. The image forming apparatus ID is the information related to the image forming apparatus that printed the image data corresponding to the hash value. The date and time information is the information related to the date and time when the image data corresponding to the hash value was printed.

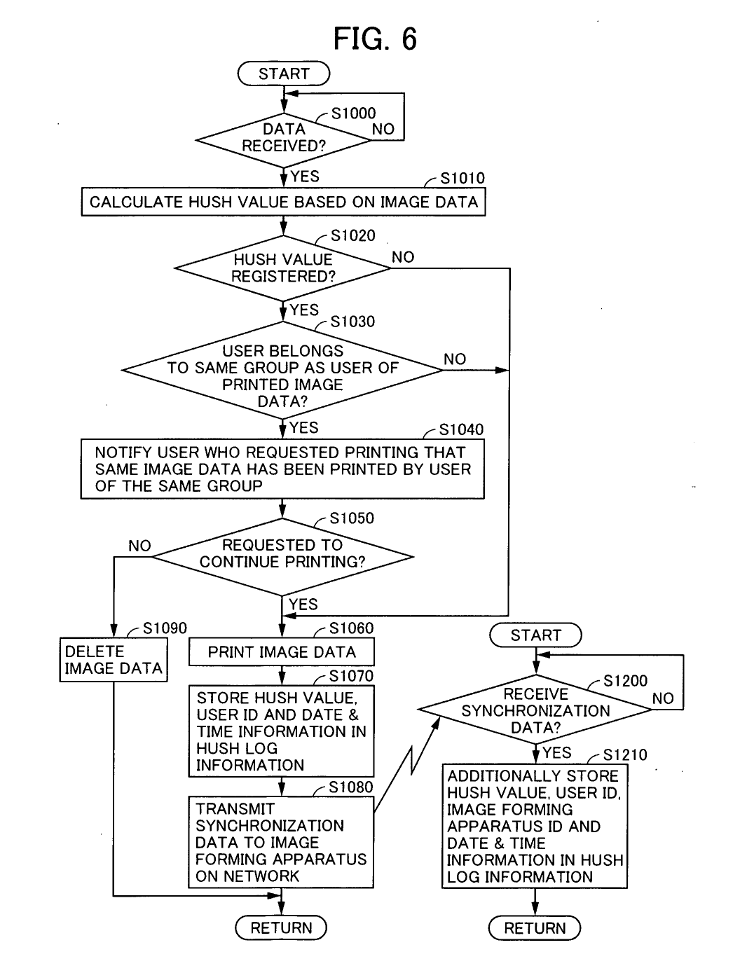

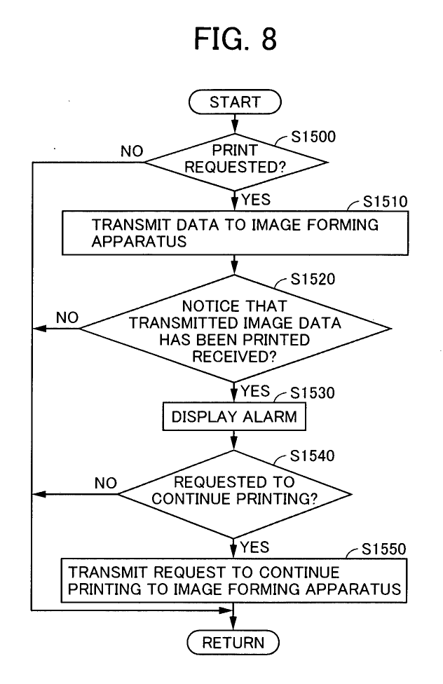

Image forming apparatus 100 in accordance with the present embodiment has a function, when a print request of image data is received from image processing terminal 200 and it is known from the hash log information stored in hash log information storage unit 156 that the image data has already been printed by a user belonging to the same group, of giving an alarm to that effect to the user of image processing terminal 200, and of continuing printing process if a command requesting continuation of printing is nevertheless issued from image processing terminal 200. In order to realize such a function, image forming apparatus 100 executes the program having a software configuration shown in FIG. 6, and image processing terminal 200 executes the program having a software configuration shown in FIG. 8, respectively.

### [Software Configuration]

FIG. 6 is a flowchart representing a control structure of a program of a process for printing image data and a program of a process for synchronizing hash log information, executed by image forming apparatus 100. In parallel with such programs, control unit 110 of image forming apparatus 100 executes programs for realizing general functions of an image forming apparatus. These programs, however, will not be discussed here, as mentioned above.

Referring to FIG. 6, at step (hereinafter “step” will be denoted by “S”) 1000, control unit 110 of image forming apparatus 100 (hereinafter simply referred to as control unit 110) determines whether or not data (image data requested to be printed, and user ID) is received from image processing terminal 200. If a user who has logged in to image processing terminal 200 using his/her user ID designates a image data and issues a print request command, control unit 210 of image processing terminal 200 transmits the user ID and the image data to image forming apparatus 100. In response, control unit 110 of image forming apparatus 100 determines that the data is received from image processing terminal 200. Malfunctions such as a communication error are not considered, since they are not directly related to the essential part of the present invention. If it is determined that the data is received (YES at S1000), the process proceeds to S1010. Otherwise

(NO at S1000), the process returns to S1000 to wait for reception of the data from image processing terminal 200. If the determination at S1000 is YES, the received data is once stored in image data storage unit 152 of storage unit 150.

At S1010, control unit 110 calculates a hash value based on the image data received from image processing terminal 200, using hash generating unit 140.

At S1020, control unit 110 determines whether or not the calculated hash value has already been registered. Here, control unit 110 determines whether the calculated hash value has already been registered or not depending on whether the hash value calculated at S1010 exists in the hash log information stored in hash log information storage unit 156. If it is determined that the calculated hash value has already been registered (YES at S1020), the process proceeds to S1050. Otherwise (NO at S1020), the process proceeds to S1060.

At S1030, control unit 110 determines whether or not the group of the user who requested printing is the same group as the user of the already printed image data. Here, control unit 110 extracts the user ID that corresponds to the hash value included in the hash log information stored in hash log information storage unit 156 and, based on the user information stored in user information storage unit 154, extracts the group (first group) to which the user identified by the extracted user ID belongs. Control unit 110 extracts the group (second group) to which the user identified by the user ID included in the data determined to be received at S1000 belongs, from the user information stored in user information storage unit 154. If the first group and the second group match, control unit 110 determines that the group of the user who requested printing is the same group as the user of the image data that has already been printed. If it is determined that the group of the user who requested printing is the same as the group of the user of the already printed image data (YES at S1030), the process proceeds to S1040. Otherwise (NO at S1030), the process proceeds to S1060. In addition to the user ID, a group ID, identifying a group to which the user identified by the user ID belongs, may be included in the data to be received at S1000. In that case, control unit 110 performs this process using the received group ID.

At S1040, control unit 110 notifies the user who requested printing of the fact that the same image data has been already printed by a user belonging to the same group, together with the image data hash value. At this time, control unit 110 controls image forming apparatus 100 such that the notification information is transmitted from image forming apparatus 100 to image processing terminal 200 used by the user who requested printing.

At S1050, control unit 110 determines whether there is a request to continue printing. Specifically, control unit 110 determines whether or not a command requesting continuation of printing has been received from image processing terminal 200 to which the notification information has been transmitted. At this time, in image processing terminal 200, if the user of image processing terminal 200 viewing the notification information (the user who requested printing of image data) issues the command requesting continuation of image data printing process, control unit 110 determines that a print continuation request is received from image processing terminal 200. If it is determined that there is a request to continue printing of image data (YES at S1050), the process proceeds to S1060. Otherwise (NO at S1050), the process proceeds to S1090.

At S1060, control unit 110 prints the image data. If the image data is printed successfully, from the viewpoint of security, control unit 110 should preferably delete the image data from image data storage unit 152.

At S1070, control unit 110 stores the hash value, the user ID and the date and time information as hash log information in hash log information storage unit 156. Here, the image forming apparatus ID in the hash log information is the information for identifying itself. At S1080, control unit 110 transmits the synchronization data to image forming apparatuses 100 on the network. The method of transmission here is, for example, simultaneous broadcast. Then, the process ends.

If the determination at S1050 is YES (that is, determination at S1020 is not NO, determination at S1030 is not NO either, and the request to continue printing is detected), preferably, the processes at S1070 and S1080 should not be executed. Specifically, as can be understood from the fact that the request to continue printing is detected, the hash log information of the image data requested to be printed is already stored in hash log information storage unit 156 and, therefore, additional storage and transmission of synchronization data are both unnecessary.

At S1090, control unit 110 deletes the image data from image data storage unit 152. Then, the process ends.

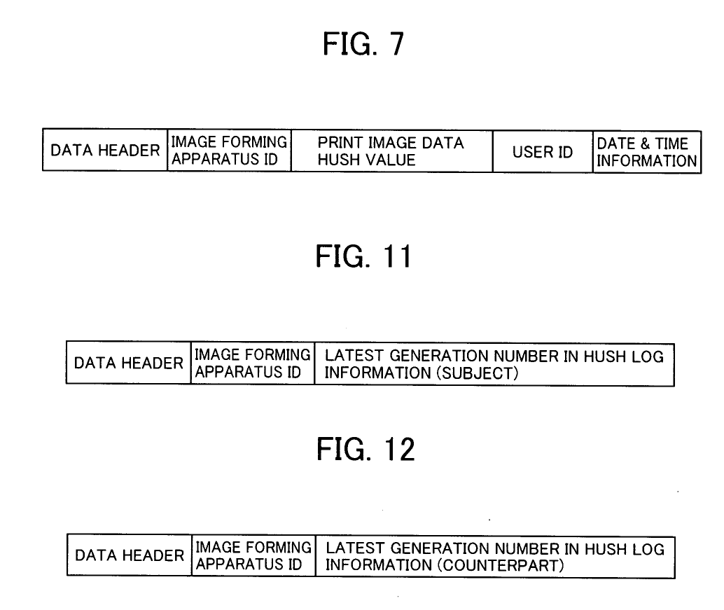

FIG. 7 shows the structure of synchronization data to be transmitted to image forming apparatus 100 on the network. The synchronization data at least includes a data header (such as identification information for identifying the type of data), the image forming apparatus ID (identification information for identifying the image forming apparatus from which the synchronization data is issued), the hash value of the printed image data, the user ID and the date and time information.

Returning to FIG. 6, at S1200, control unit 110 of image forming apparatus 100 other than the apparatus to handle the print request determines whether or not the synchronization data shown in FIG. 7 is received. If it is determined that the synchronization data is received (YES at S1200), the process proceeds to S1210. Otherwise (NO at S1200), the process is returned to S1200, to wait until the synchronization data is received.

At S1210, control unit 110 of image forming apparatus 100 other than the apparatus to handle the print request adds the hash value, user ID, image forming apparatus ID and date and time information to the hash log information, and stores the added hash log information in hash log information storage 156.

The process by image forming apparatus 100 to handle the print request and the process by other image forming apparatuses 100 not to handle the print request may not be distinguished from each other. In that case, image forming apparatus 100 may be controlled such that if it receives the synchronization data issued by itself, the process of S1210 is not executed, or the hash log information is overwritten.

FIG. 8 is a flowchart representing a control structure of a program of a process for printing image data executed by image processing terminal 200. In parallel with such programs, control unit 210 of image processing terminal executes programs for realizing general functions of a computer. These programs, however, will not be discussed here, as mentioned above.

Referring to FIG. 8, at S1500, control unit 210 of image processing terminal 200 (hereinafter simply referred to as control unit 210) determines whether or not a print request is detected. By way of example, if a user executing a word processing software activates a printer driver and a print button (a button displayed by software on display unit 230) is designated and clicked by a mouse as input unit 220, control unit 210 detects the print request. If the print request is detected (YES at S1500), the process proceeds to S1510. Otherwise (NO at S1500), the process ends.

At S1510, control unit 210 transmits data (user ID and image data) to image forming apparatus 100. This corresponds to the process at S1000 of FIG. 6.

At S1520, control unit 210 determines whether or not a notice that the transmitted image data has already been printed is received. This corresponds to the process at S1040 of FIG. 6. If a notice that the transmitted image data has already been printed (YES at S1520), the process proceeds to S1530. Otherwise (NO at S1520), the process ends.

At S1530, control unit 210 displays an alarm on display unit 230. At this time, a selection button to select whether or not the print request is to be continued, is displayed together with the alarm, on display unit 230.

At S1540, control unit 210 determines whether or not a request to continue printing is detected. Here, the select button for selecting whether to continue print request or not is displayed on display unit 230, and if the button to continue the print request is designated and clicked by a mouse or the like as input unit 220, control unit 210 detects the request to continue printing. If the request to continue printing is detected (YES at S1540), the process proceeds to S1550. Otherwise (NO at S1540), the process ends.

At S1550, control unit 210 transmits the request to continue printing, to the image forming apparatus 100 that notified the fact that the image data has already been printed (transmitted the alarm information). This corresponds to the process at S1050 of FIG. 6. Then, the process ends.

### [Operation]

The operation of image forming apparatus 100 and image processing terminal 200 in accordance with the present embodiment based on the structures and flowcharts above will be described in the following.

### Image Data Printing Operation (Part 1)

In the following, an operation when the same image data has already been printed by a user of the same group will be described.

A user A belonging to group 001 logs in to image processing terminal 200 using his/her user ID, designates an image data (here, denoted as “Image Data A”), and issues a print request command. The data (Image Data A and user ID) is transmitted from image processing terminal 200 to image forming apparatus 100, and in image forming apparatus 100, it is determined that the data (Image Data A and user ID) is received from image processing terminal 200 (YES at S1000).

The image data received from image processing terminal 200 (Image Data A) is stored in image data storage unit 152. Based on the image data, a hash value is calculated (S1010). The hash value here is assumed to be the fifth value from the top of hash log information shown in FIG. 5. Specifically, the hash value that corresponds to “Image Data A” has already been registered in the hash log information, and Image Data A has already been printed by a user B who belongs to group 001.

The hash value corresponding to Image Data A has already been registered in the hash log information (YES at S1020), and the user A who requested printing from image processing terminal 200 belongs to the same group 001 as the user B of already printed Image Data A (YES at S1030). Therefore, the fact that the same Image Data A has already been printed by user B belonging to the same group 001 is notified to user A who requested printing of the image data (YES at S1040, YES at S1500).

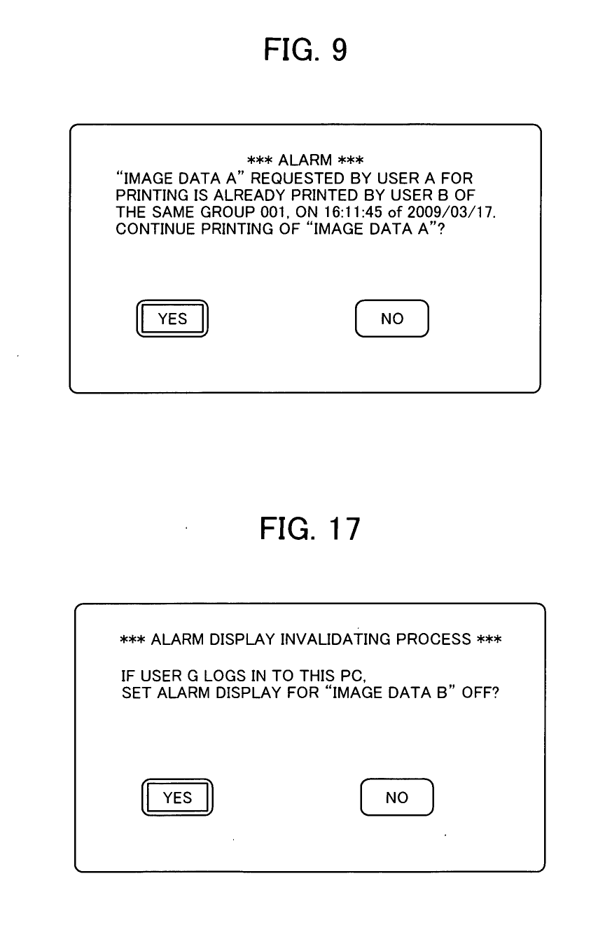

At this time, on display unit 230 of image processing terminal 200 to which user A is logged in, a notice such as shown in FIG. 9 is displayed (S1530). As can be seen from FIG. 9, a notice “'IMAGE DATA A′ REQUESTED BY USER A FOR PRINTING IS ALREADY PRINTED BY USER B OF THE SAME GROUP 001, ON 16:11:45 of 2009, Mar. 17. CONTINUE PRINTING OF ‘IMAGE DATA A’?” is presented to user A.

If user A still requests to continue printing even if such a notice is displayed (YES at S1540, YES at S1550 and S1050), printing is done by image forming apparatus 100 using Image Data A stored in image data storage unit 152 (S1060).

If such a notice is displayed and user A cancels the print request for Image Data A (NO at S1540, NO at S1050), Image Data A is not printed by image forming apparatus 100, and Image Data A is deleted from image data storage unit 152 (S1080).

### Image Data Printing Operation (Part 2)

In the following, an operation if the same image data has not yet been printed, or printed by a user of a different group will be described.

This is the case that the hash value corresponding to the image data of which printing is requested by user A is not yet registered in the hash log information (NO at S1020), or the image data has been printed but the user who requested printing from image processing terminal 200 belongs to a group different from the user of the already printed image data (NO at S1030). In that case, no notice is issued to user A who requested printing of the image data, and the image data is printed by image forming apparatus 100 (S1060).

If the image data is printed, the hash value, the user ID and the date and time information of the printed image data are stored as the hash log information in hash log information storage unit 156.

To the image forming apparatus 100 on the network, synchronization data is transmitted (S1080), and by the image forming apparatus 100 receiving the synchronization data, the hash value, the user ID, the image forming apparatus ID and the date and time information included in the received synchronization data are added to the hash log information, and the added hash log information is stored in hash log information storage unit 156 (S1210). Thus, the hash log information of image forming apparatuses 100 on the network are synchronized and stored in the hash log information storage units 156.

As described above, according to the print service system of the present embodiment, image data is transmitted from an image processing terminal such as a PC through the network to an image forming apparatus (printer), and the print process is executed. In such a situation, if the same image data has been already printed by a user of the same group, a notice to that effect is given to a user who requested printing. Receiving such a notice, the user may become aware of the waste and refrain from printing, since it may be sufficient to refer to the previously provided print-out (since it is often the case that the user belonging to the same group stays nearby) if the purpose is just a rough confirmation of printed image (color, tone and overall balance). This approach effectively prevents accumulative printing of the same image data and cuts waste.

In order to execute such a process by a configuration including image forming apparatuses only (not requiring a server computer) on the network, it is necessary that, among the plurality of image forming apparatuses, synchronized hash log information is stored in each image forming apparatus 100. In the print service system in accordance with the present embodiment, when printing of image data is executed by one image forming apparatus, the synchronization data is simultaneously broadcast to other image forming apparatuses on the network. Receiving the data, each image forming apparatus stores, in its hash log information storage, the hash log information included in the received synchronization data. Therefore, by a configuration including image forming apparatuses only (not including a server computer), accumulative printing of the same image data can effectively be prevented, and waste can be reduced.

As regards the hash value generated from the image data, the hash value may be generated regarding the image data as a whole as one image data, or if the image data contains a plurality of pages, a hash value may be generated for each page.

Further, in the embodiment described above, the process of S1040 is executed if the conditions of S1020 and S1030 are satisfied. The conditions of S1030, however, may be omitted. In that case, if the image data has already been printed (regardless of the group), a notice to that effect is given to the user who requested printing.

Though hash log information shown in FIG. 5 has small data amount, it is preferred to conduct maintenance at an appropriate time interval to remove old information. An upper limit of elapsed time from printing may be set and if the upper limit is reached, the information may be deleted from the older one, or an upper limit of data amount may be set and if the upper limit is reached, the information may be deleted from the older one. In that case, it is possible not to delete the older hash log information corresponding to the request to continue printing, or such hash log information may positively be deleted. Such an approach eliminates the necessity of increasing the capacity of the hash log information storage unit.

### Second Embodiment

In the following, a print service system in accordance with a second embodiment of the present invention will be described. In the description of the present embodiment, description of portions similar to those of the embodiment above will not be repeated. Specifically, the same components or same processes as in the above-described embodiment are denoted by the same reference characters and, therefore, description thereof will not be repeated.

In the present embodiment, a synchronizing process when image forming apparatus 100 is activated (when power is switched from OFF to ON) will be described. When the power of image forming apparatus 100 is switched from OFF to ON, in order for the image forming apparatus 100 to obtain the latest hash log information, or to have other image forming apparatuses 100 obtain the latest hash log information, a synchronizing process at activation is performed.

### [Software Configuration]

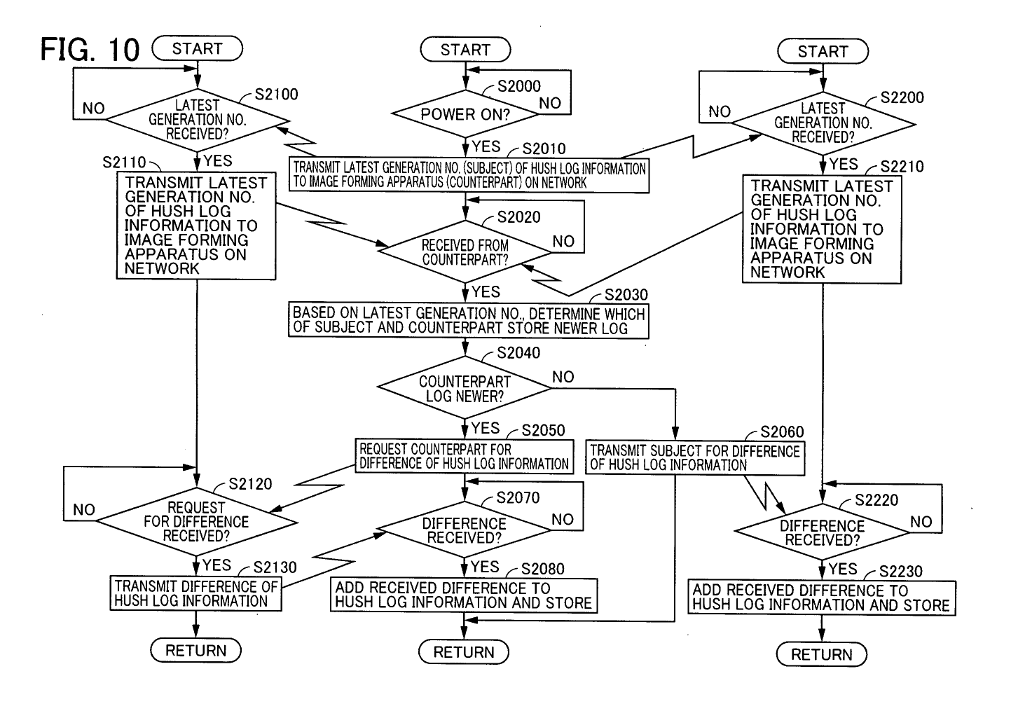

FIG. 10 is a flowchart representing a control structure of a program for the synchronizing process at the time of activation, executed by image forming apparatus 100. In FIG. 10, the central flowchart represents the program executed by control unit 110 of image forming apparatus (1) 100 that is switched from power OFF to ON; the left flowchart represents a program executed by control unit 112 of image forming apparatus (2) 102 storing hash log information newer than that of image forming apparatus (1) 100 that is powered ON; and the right flowchart represents a program executed, if the image forming apparatus 100 that is powered ON stores new hash log information, by control unit 112 and control unit 114 of other image forming apparatuses (2) 102 and (3) 104. The three programs represented by the flowcharts shown in FIG. 10 are executed by all image forming apparatuses 100.

Referring to the central flowchart of FIG. 10, at S2000, control unit 110 of image forming apparatus 100 (hereinafter simply referred to as control unit 110) determines whether or not the power is turned ON. It is assumed that even if the power is OFF, it is possible by control unit 110 to detect power ON. If it is determined that the power is turned ON (YES at S2000), the process proceeds to S2010. Otherwise (NO at S2000), the process is returned to S2000, to wait until the power is switched from OFF to ON.

At S2010, control unit 110 transmits the latest generation number data of itself (subject) indicating the generation number of hash log information, to image forming apparatuses on the network (image forming apparatuses (2) 102 and (3) 104 as counterparts). At this time, the method of transmission is, for example, simultaneous broadcast, and the latest generation number data (subject) to be transmitted has such a structure as shown in FIG. 11. The generation means the line number of the last line of hash log information shown in FIG. 5.

At S2020, control unit 110 determines whether the latest generation number data (from counterpart) is received from the image forming apparatuses on the network (image forming apparatuses (2) 102 and (3) 104 as counterparts). In response to reception of the latest generation number data (subject) from the image forming apparatus 100 as the subject machine, image forming apparatuses (2) 102 and (3) 104 as counterparts transmit the latest generation number data to the image forming apparatus 100 as the subject machine. Here, the latest generation number data (subject) may be considered as an inquiry of latest generation number transmitted from the subject machine to the counterpart. At this time, the method of transmission is, for example, simultaneous broadcast, and the latest generation number data (counterpart) to be transmitted has such a structure as shown in FIG. 12. If it is determined that the latest generation number data of hash log information (counterpart) is received (YES at S2020), the process proceeds to S2030. Otherwise (NO at S2020), the process is returned to S2020, to wait until the latest generation number data (counterpart) of hash log information is received. As regards the latest generation number (counterpart) of the latest generation number data received at this time, it follows that the same data is received, since synchronization is established among the apparatuses other than image forming apparatus (1) 100. The data may be received from one specific image forming apparatus.

At S2030, control unit 110 determines, based on the latest generation number of the subject and the latest generation number of the counterpart, which of the subject and counterpart apparatuses store the newer hash log information. The one whose latest generation number is larger is determined to store newer hash log information.

At S2040, control unit 110 determines whether the hash log information of the counterpart is newer than itself (subject). If it is determined that the hash log information of the counterpart is newer (YES at S2040), the process proceeds to S2050. Otherwise (NO at S2040), the process proceeds to S2060.

At S2050, control unit 110 requests the counter part for difference of hash log information. Since the hash log information of the counterpart is newer than that of itself, it follows that the subject machine is to be synchronized to the hash log information of the counterpart. Here, image forming apparatuses (image forming apparatuses (2) 102 and (3) 104) other than the subject image forming apparatus (1) have synchronized hash log information. Therefore, the request may be made to any of the image forming apparatuses on the network (other than the subject image forming apparatus (1) 100). Here, it is assumed that the request is made to image forming apparatus (2) 102. Then, the process proceeds to S2070.

At S2060, control unit 110 transmits the difference of hash log information to the counterpart. Since the hash log information of the counterpart is not newer than that of itself (subject apparatus has newer information), it follows that the counterparts are to be synchronized to the hashlog information of the subject apparatus. Here, in order that all image forming apparatuses (image forming apparatuses (2) 102 and (3) 104) other than the subject image forming apparatus (1) have synchronized hash log information, the difference is transmitted to all the image forming apparatuses on the network. Here, an example of transmission to image forming apparatus (3) 104 will be described. The same process is performed in image forming apparatus (2) 102. Then, the process ends.

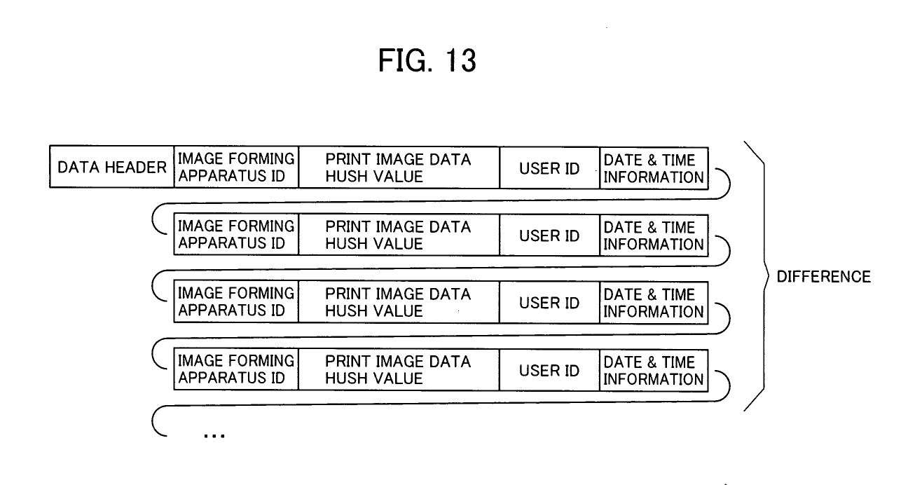

The data amount of difference (generation number of difference) at S2050 and S2060 corresponds to |latest generation number of subject—latest generation number of counterpart| (absolute value of difference). At S2050, control unit 110 requests the hash log information corresponding to the absolute value of difference. At S2060, control unit 110 reads the hash log information of the absolute value of difference from hash log information storage unit 156 of itself, and transmits this as the difference data. The difference data has a structure shown in FIG. 13, in which following the data header, pieces hash log information each corresponding to one generation, consisting of image forming apparatus ID, print image data hash value, user ID and date and time information, are provided.

At S2070, control unit 110 determines whether or not the difference of hash log information is received. At this time, image forming apparatus (2) 102 as the counterpart, of which difference has been requested, transmits the difference data (FIG. 13) in response to the request. If it is determined that the difference of hash log information has been received (YES at S2070), the process proceeds to S2080. Otherwise (NO at S2070), the process is returned to S2070, to wait until the difference of hash log information is received.

At S2080, based on the received difference data, control unit 110 adds the hash value, user ID, image forming apparatus ID and date and time information included in the received difference to the hash log information, and stores the added hash log information to hash log information storage unit 156.

Referring to the left flowchart of FIG. 10, at S2100, control unit 112 of image forming apparatus (2) 102 (hereinafter simply referred to as control unit 112) determines whether or not the latest generation number data (subject) is received from image forming apparatus (1) 100. This corresponds to the process at S2010. If it is determined that the latest generation number data (subject) has been received (YES at S2100), the process proceeds to S2110. Otherwise (NO at S2100), the process is returned to S2100, to wait until the latest generation number data (subject) is received.

At S2110, control unit 112 transmits the latest generation number data (counterpart) indicating the generation number of hash log information stored in the hash log information storage unit 156 of itself, to image forming apparatus (1) 100. In response to this process, determination at S2020 becomes YES.

At S2120, control unit 112 determines whether or not a request for difference of the log information is received from image forming apparatus (1) 100. This corresponds to the process at S2050. If it is determined that the request for difference of hash log information has been received, the process proceeds to S2130. Otherwise (NO at S2120), the process is returned to S2120, to wait until the request for difference is received.

At S2130, control unit 112 transmits the difference of hash log information. In response to this process, determination at S2070 becomes YES. At S2130, control unit 112 reads the hash log information corresponding to the absolute value of difference described above from hash log information storage unit 156 of itself, and transmits this as the difference data (FIG. 13).

Referring to the right flowchart of FIG. 10, at S2200, control unit 114 of image forming apparatus (3) 104 (hereinafter simply referred to as control unit 114) executes the same process as that of S2100 described above. At S2210, control unit 114 executes the same process as that of S2110 described above.

At S2220, control unit 114 determines whether or not the difference of hash log information is received. At this time, image forming apparatus (1) 100 that is powered ON from OFF has newer hash log information and, therefore, it transmits the difference data (FIG. 13). If it is determined that the difference of hash log information has been received (YES at S2220), the process proceeds to S2230. Otherwise (NO at S2220), the process is returned to S2220, to wait until the difference of hash log information is received.

At S2230, based on the received difference data, control unit 114 adds the hash value, user ID, image forming apparatus ID and date and time information included in the received difference to the hash log information, and stores the added hash log information to hash log information storage unit 156.

### [Operation]

Operations of image forming apparatuses (1) 100, (2) 102 and (3) 104 in accordance with the present embodiment based on the structures and flowcharts above will be described in the following.

Synchronizing Operation (Image Forming Apparatus that is Powered ON is Synchronized by Other Apparatuses)

In the following, an example in which image forming apparatus 100 whose power is turned from OFF to ON is synchronized by other image forming apparatus (2) 102 will be described. This is an operation when hash log information of image forming apparatus (2) 102 is newer than hash log information of image forming apparatus (1) 100.

If the power of image forming apparatus (1) 100 is switched from OFF to ON (YES at S2000), the latest generation number data (subject) indicating the generation number of hash log information stored in hash log information storage unit 156 is transmitted to image forming apparatuses on the network (image forming apparatuses (2) 102 and (3) 104 as counterparts) (S2010).

Receiving the latest generation number data (YES at S2100, YES at S2200), image forming apparatus (2) 102 and/or image forming apparatus (3) 104 transmits the latest generation number data (counterpart) indicating the generation number of hash log information stored in hash log information storage unit 156 of each image forming apparatus to image forming apparatus (1) 100 (S2110, S2210).

Receiving the latest generation number data (counterpart) (YES at S2020), image forming apparatus (1) 100 whose power is turned from OFF to ON determines whether the apparatus itself (subject) or the counterpart stores the newer hash log information (S2030). In the description of operation here, it is assumed that the hash log information of image forming apparatus (2) 102 is newer than the hash log information of image forming apparatus (1) 100 (YES at S2040) and, therefore, a request for the difference of hash log information is issued to other image forming apparatuses (2) 102 and (3) 104 (S2050).

If the difference of hash log information is requested (YES at S2120), the other image information apparatus (2) 102 reads the hash log information corresponding to {latest generation number of subject apparatus (here, image forming apparatus (2) 102)—latest generation number of counterpart (here, image forming apparatus (1) 100)} from hash log information storage unit 156 of image forming apparatus (2) 102. The read hash log information is transmitted as the difference data (FIG. 13) to image forming apparatus (1) 100 whose power has been turned from OFF to ON (S2130).

If image forming apparatus (1) 100 whose power is turned from OFF to ON receives the difference (YES at S2070), the received difference is added to the hash log information and stored in hash log information storage unit 156 (S2080).

Consequently, the hash log information of image forming apparatus (1) 100 whose power is turned from OFF to ON is made the same as that of other image forming apparatuses on the network, that is, synchronized.

Specifically, the hash log information of the image forming apparatus that is powered ON is synchronized by other image forming apparatuses.

Synchronizing Operation (Other Apparatuses are Synchronized by Image Forming Apparatus that is Powered ON)

In the following, an example in which other image forming apparatus (3) 104 is synchronized by image forming apparatus 100 whose power is turned from OFF to ON will be described. This is an operation when hash log information of image forming apparatus (1) 100 is newer than hash log information of image forming apparatus (3) 104. It is noted that not only image forming apparatus (3) 104 but also image forming apparatus (2) 102 are synchronized by image forming apparatus (1) 100.

Receiving the latest generation number data (counterpart) (YES at S2020), image forming apparatus (1) 100 whose power is turned from OFF to ON determines whether the apparatus itself (subject) or the counterpart stores the newer hash log information (S2030). In the description of operation here, it is assumed that the hash log information of image forming apparatus (1) 100 is newer than the hash log information of image forming apparatus (3) 104 (NO at S2040) and, therefore, the difference of hash log information is transmitted to other image forming apparatuses (2) 102 and (3) 104 (S2060) (in the following, only the operation in image forming apparatus (3) 104 will be described). At this time, image forming apparatus (1) 100 whose power is turned from OFF to ON reads the hash log information corresponding to {latest generation number of subject apparatus (here, image forming apparatus (1) 100)—latest generation number of counterpart (here, image forming apparatus (3) 104)} from hash log information storage unit 156 of image forming apparatus (1) 100. The read hash log information is transmitted as difference data (FIG. 13) to image forming apparatus (3) 104 (YES at S2220).

In image forming apparatus (3) 104 that received the difference from image forming apparatus (1) 100 whose power is turned from OFF to ON, the received difference is added to the hash log information and stored in hash log information storage unit 156 (S2230).

Consequently, the hash log information of image forming apparatus (1) 100 whose power is turned from OFF to ON is made the same as that of other image forming apparatuses on the network, that is, synchronized. Thus, the hash log information of other image forming apparatuses are synchronized by image forming apparatus that is powered ON.

As described above, according to the image forming apparatus of the present embodiment, even if the power of image forming apparatus of interest is off while an image data is printed by other image forming apparatus, when the image forming apparatus of interest is turned from OFF to ON, it receives difference of hash log information from other image forming apparatus and, thus, synchronization of hash log information is established among image forming apparatuses on the network. If image forming apparatus whose power is switched from OFF to ON has the latest hash log information, the image forming apparatus whose power is switched from OFF to ON transmits the difference of hash log information to other image forming apparatuses and, thus, synchronization of hash log information is established among image forming apparatuses on the network. Therefore, even by a configuration including image forming apparatuses only and not requiring a server computer (an image processing terminal is necessary), synchronization of hash log information can reliably be established and, therefore, accumulative printing of the same image data can effectively be prevented and waste can be reduced.

If an image forming apparatus not storing any hash log information (for example, a brand-new apparatus) is set to be recognizable in the network and powered ON, hash log information corresponding to all generations (all data of hash log information) is transmitted from other image forming apparatus, the received difference is added to the hash log information and stored in hash log information storage unit 156.

### Third Embodiment

In the following, a print service system in accordance with a third embodiment of the present invention will be described. In the description of the present embodiment, description of portions similar to those of the embodiment above will not be repeated. Specifically, the same components or same processes as in the above-described embodiments are denoted by the same reference characters and, therefore, description thereof will not be repeated.

In the present embodiment, a display invalidating process controlling display unit 230 of image processing terminal 200 not to display an alarm, will be described. The display invalidating process takes place if the same user prints the same image repeatedly (for example, to output monthly ledger), to prevent repeated display of the alarm.

### [Hardware Configuration]

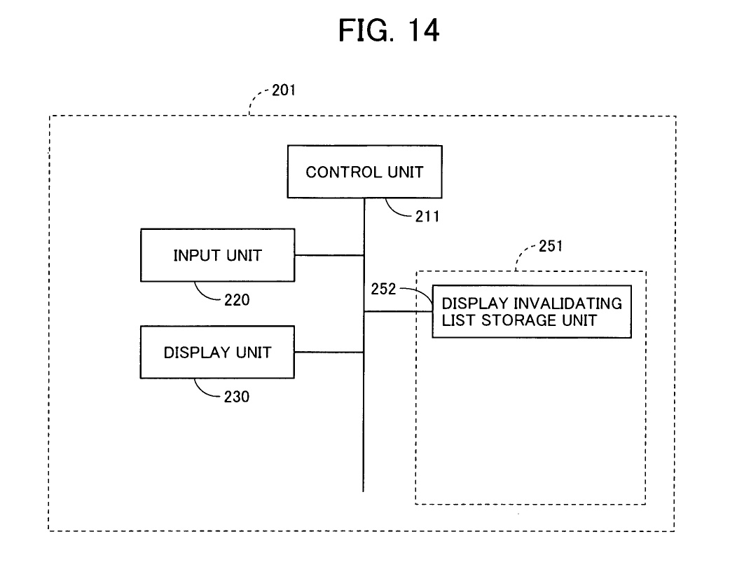

FIG. 14 is a functional block diagram showing hardware configuration of an image processing terminal 201 in accordance with the present embodiment. Similar to image processing terminal 200 shown in FIG. 3, image processing terminal 201 has the same configuration as a general PC.

The difference from image processing terminal 200 will be described in the following. Image processing terminal 201 in accordance with the present embodiment includes a control unit 211 executing a program different from that of control unit 210, and a storage unit 251 including a display invalidating list storage unit 252 (input unit 220 and display unit 230 are the same).

Storage unit 251 may be implemented by an HDD (Hard Disk Drive) or a flash memory, which is a non-volatile storage area capable of storing data and the like even when power of image processing terminal 201 is turned off.

Storage unit 251 includes a display invalidation list storage unit 252.

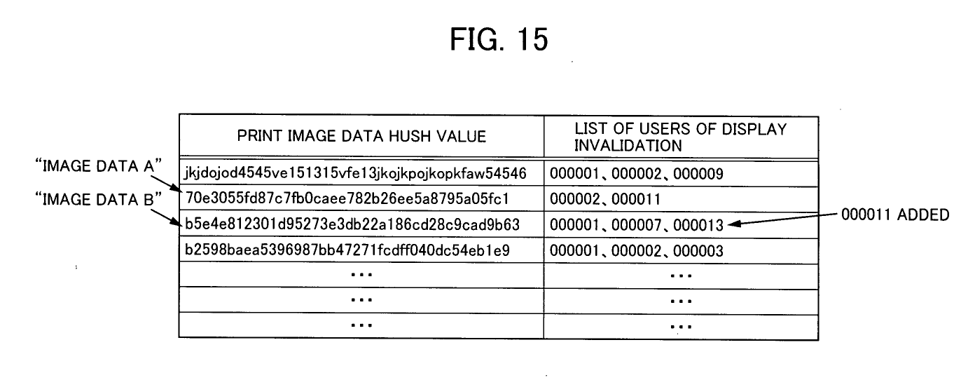

In display invalidation list storage unit 252, image data for which an alarm is not to be displayed are stored, in accordance with an alarm display invalidation storage table such as shown in FIG. 15.

Referring to FIG. 15, the display invalidation list stored in display invalidation list storage unit 252 will be described.

As shown in FIG. 15, display invalidation list is stored in the alarm display invalidation storage table including a field for storing a list of users for whom the alarm display is invalidated, with the print image data hash value used as a key. In the list of users, each user is identified by the user ID.

As shown in FIG. 15, for Image Data A that corresponds to the hash value second from the top, the alarm display is set to be invalidated for the user having user ID “000002” and user name “User B” and the user having user ID “000011” and user name “User G.”

When Image Data A is transmitted from image processing terminal 201 to image forming apparatus 100 and the same Image Data A has already been printed by a user belonging to the same group, the operation is as follows. If the user is other than User B and User G registered for Image Data A, an alarm is displayed on display unit 230 (FIG. 9), since only User B and User G are stored in the display invalidation list corresponding to the image data hash value received from image forming apparatus 100. If the user is User B or User G stored for Image Data A, an alarm is not displayed on display unit 230, since User B and User G are stored in the display invalidation list corresponding to the image data hash value received from image forming apparatus 100. In this manner, image processing terminal 201 is controlled such that no alarm is displayed, based on the display invalidation list.

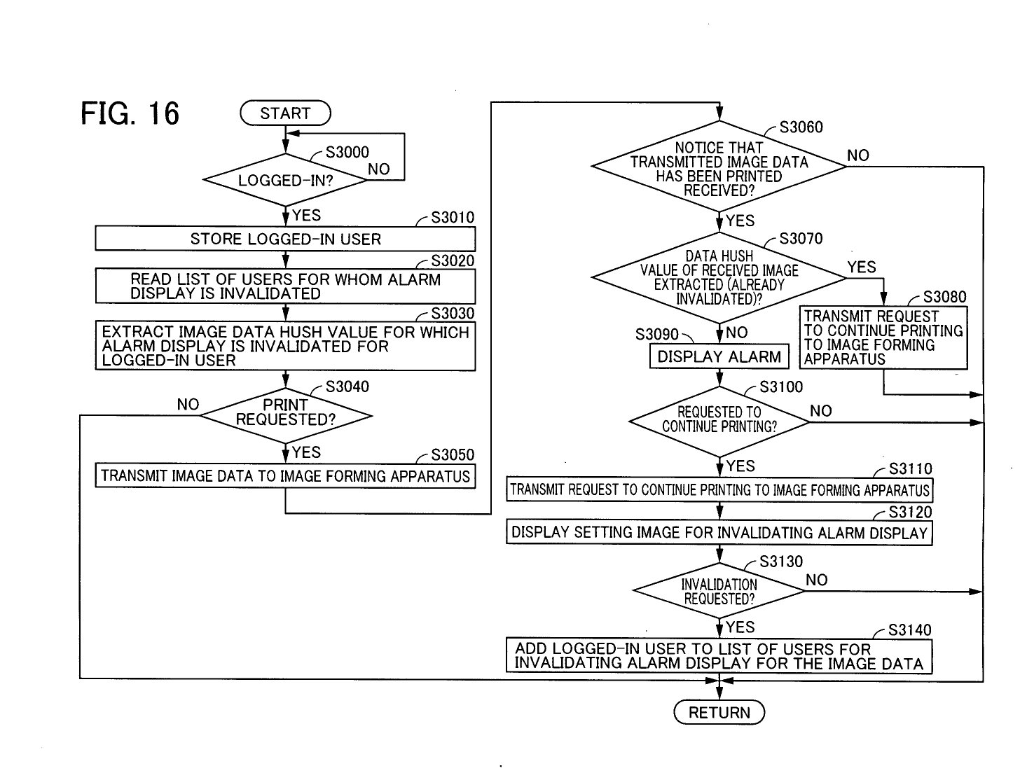

Image processing terminal 201 in accordance with the present embodiment has a function of setting not to display an alarm, and a function of performing the alarm display process based on the settings. In order to realize such a function, image processing terminal 201 executes a program that has the software configuration shown in FIG. 16.

### [Software Configuration]

FIG. 16 is a flowchart representing a control structure of a program of a process for printing image data executed by image processing terminal 201. In parallel with such programs, control unit 211 of image processing terminal 201 executes programs for realizing general functions of a computer. These programs, however, will not be discussed here, as mentioned above.

Referring to FIG. 16, at S3000, control unit 211 of image processing terminal 201 (hereinafter simply referred to as control unit 211) determines whether or not a user has logged in to image processing terminal 201. At this time, the user logs in using user ID, user name or identification information that allows unique identification of the user. In the following, it is assumed that the user logs in using user ID. If it is determined that a user has logged in to image processing terminal 201 (YES at S3000), the process proceeds to S3010. Otherwise (NO at S3000), the process is returned to S3000, to wait until a user logs in.

At S3010, control unit 211 stores the user who logged in, using user ID. At S3020, control unit 211 reads the list of users (FIG. 15) for whom alarm display is to be invalidated. At S3030, control unit 211 extracts, from the list of users, image data hash values set to invalidate alarm display for the logged-in user. For user B who has logged in with his/her user ID “000002,” the print image data hash value first from the top, the print image data hash value second from the top and the print image data hash value fourth from the top shown in FIG. 15 are extracted. At S3040, control unit 211 performs the same process as S1500 of FIG. 8. At S3050, control unit 211 performs the same process as S1510 of FIG. 8. At S3060, control unit 211 performs the same process as S1520 of FIG. 8.

At S3070, control unit 211 determines whether or not the image data hash value received from image forming apparatus 100 is the same as any of the values extracted at S3030. If the received image data hash value is the extracted value, it means that a process for invalidating the alarm display has already been done (already registered in the list of users of display invalidation shown in FIG. 15). If the image data hash value received from image forming apparatus 100 is the extracted value (YES at S3070), the process proceeds to S3080. Otherwise (NO at S3070), the process proceeds to S3090.

At S3080, control unit 211 transmits a request to continue printing to image forming apparatus 100 without displaying an alarm (FIG. 9) to the user. Then, the process ends.

At S3090, control unit 211 performs the same process as S1530 of FIG. 8. At S3100, control unit 211 performs the same process as S1540 of FIG. 8. At S3110, control unit 211 performs the same process as S1550 of FIG. 8.

At S3120, control unit 211 displays a setting image for invalidating the alarm display on display unit 230. At S3130, control unit 211 determines whether or not a request for invalidating the alarm display is detected. By way of example, a selection button for invalidating the alarm display is displayed on display unit 230, and if the button requesting invalidation is designated and clicked by a mouse or the like as input unit 220, control unit 211 detects the alarm display invalidating request. If the request for invalidating alarm display is detected (YES at S3130), the process proceeds to S3140. Otherwise (NO at S3130), the process ends.

At S3140, control unit 211 adds the user who is logged in to image processing terminal 201, to the list of users for whom the alarm display for the image data is invalidated. Then, the process ends.

### [Operation]

The operation of image processing terminal 201 in accordance with the present embodiment based on the structures and flowcharts above will be described with reference to FIG. 17. In the following, description of the same operation as described in the embodiments above will not be repeated.

Operation when User G Requested Printing of Already Printed Image Data A

If User G logs in to information processing terminal 201 with his/her user ID “000011” (YES at S3000), the logged-in user is stored (S3010). Further, the list of users for whom the alarm display is invalidated (FIG. 15) is read (S3020), and data hash value or values set to invalidate the alarm display for logged-in User D (user ID “000011”) are extracted. At this time, as shown in FIG. 15, print image data hash value registered for the logged-in user G as the user for whom alarm display is to be invalidated (in this example, print image data hash value for Image Data A) is extracted.

If the logged-in user G (user ID “000011”) requests printing of Image Data A (YES at S3040), Image Data A is transmitted to image forming apparatus 100 (S3050). In the description of operation here, it is assumed that Image Data A has already been printed by a user belonging to the same group as User G.

Since transmitted Image Data A has already been printed by the user of the same group, a notice that Image Data A has been printed is received (YES at S3060). Since the received image data hash value is already registered to invalidate the alarm display for logged-in User G (YES at S3070), the request to continue printing is transmitted to image forming apparatus 100 without displaying any alarm (S3080).

Therefore, for logged-in User G, Image Data A is printed by image forming apparatus 100 with the alarm not displayed on display unit 230.

Operation when User G Requested Already Printed Image Data B

If logged-in User G (user ID “000011”) requests printing of Image Data B (YES at S3040), Image Data B is transmitted to image forming apparatus 100 (S3050). In the description of operation here, it is assumed that Image Data B has already been printed by a user belonging to the same group as User G.

Since transmitted Image Data B has already been printed by the user of the same group, a notice that Image Data B has been printed is received (YES at S3060). Since the received image data hash value is not registered to invalidate the alarm display for logged-in User G (NO at S3070), an alarm such as shown in FIG. 9 is displayed (S3090).

If user G requests to continue printing of Image Data B (YES at S3100), the request to continue printing is transmitted to image forming apparatus 100 (S3110).

For user G who logged in to image processing terminal 201 and requested printing of Image Data B, if the alarm is displayed on display unit 230 and still continuation of printing is requested (YES at S3100), Image Data B is printed by image forming apparatus 100.

Here, if continuation of printing is requested even after the alarm is displayed, a setting image for the alarm display invalidating process shown in FIG. 17 is displayed on display unit 230 (S3120). At this time, on display unit 230, a message “IF USER G LOGS IN TO THIS PC, SET ALARM DISPLAY FOR ‘IMAGE DATA B’ OFF?” is displayed on display unit 230. If it is selected on the setting image of FIG. 17 to turn off the alarm display (YES at S3130), User G who has logged in to image processing terminal 201 is added to the list of users for whom the alarm display for Image Data B is invalidated. At this time, as shown in FIG. 15, user ID “000011” of User G is stored in association with print image data hash value of Image Data B.

For User G who logged in to image processing terminal 201 and requested printing of Image Data B, if a request to invalidate the alarm display on the selection image displayed after the alarm is given, it follows that Image data B is printed by image forming apparatus 100 with no alarm displayed on display unit 230.

In the manner as described above, by the image processing terminal in accordance with the present embodiment, it is possible to control not to display an alarm even if the same image data has already been printed by a user belonging to the same group. Thus, when the same user prints the same data repeatedly, repeated display of the alarm complicating the printing procedure can be avoided.

If maintenance of the list of users for invalidating the alarm display shown in FIG. 15 is necessary (for example, if the alarm display is once invalidated and thereafter alarm display is again required), corresponding user name may be deleted by an appropriate procedure.

In the image processing terminal in accordance with the present embodiment, the alarm display invalidating process is done if continuous printing is requested after the alarm is displayed. The process steps of S3120, S3130 and S3140, however, may be executed separately.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

1. An image forming apparatus used in an image forming system in which an image data to be printed from an image processing terminal is transmitted to and printed by any of a plurality of image forming apparatuses connected by a network, comprising:
a receiving unit receiving, from said image processing terminal, said image data and user information identifying a user who requested printing of said image data;
a generating unit generating identification data enabling unique identification of said image data, based on said received image data;
a printing unit printing an image based on said image data;
a storage unit storing, when the image is printed, the identification data corresponding to the printed image in association with said user information;
a notifying unit providing said image processing terminal with alarm information for outputting an alarm on said image processing terminal, if the identification data corresponding to the image data received from said image processing terminal has been stored in said storage unit;
a transmitting unit transiting synchronization data including said identification information and said user information stored in said storage unit to an image forming apparatus connected to the network; and
a control unit controlling said storage unit such that when said synchronization data is received from said image forming apparatus, the image data and the user information included in said synchronization data are stored in association with each other.

2. The image forming apparatus according to claim 1, wherein said alarm information indicates that the image has already been printed based on said received image data by any of the plurality of image forming apparatuses.

3. The image forming apparatus according to claim 1, further comprising:
a group storage unit storing a group to which said user belongs; wherein
said notifying unit issues said alarm information to said image processing terminal, if said identification data is stored in said storage unit and printing has been already done by a user of the same group.

4. The image forming apparatus according to claim 1, wherein
said transmitting unit transmits a difference newly stored in said storage unit when the image is printed, as the synchronization data, to said image forming apparatus.

5. The image forming apparatus according to claim 1, further comprising:
a determining unit determining whether or not data stored in said storage unit is synchronized with data stored in other image forming apparatus; and
an obtaining unit obtaining data to be stored in said storage unit depending on the determination by said determining unit.

6. The image forming apparatus according to claim 5, wherein
said obtaining unit obtains the data to be stored in said storage unit from other image forming apparatus, if it is determined that data stored in said storage unit is older than and not synchronized with data stored in said other image forming apparatus.

7. The image forming apparatus according to claim 6, wherein
said obtaining unit requests said other image forming apparatus for a difference between the data stored in said storage unit and data stored in the storage unit of said other image forming apparatus, and obtains the difference from said other image forming apparatus.

8. The image forming apparatus according to claim 7, further comprising:
a difference transmitting unit transmitting the difference to other image forming apparatus when the difference is requested by said other image forming apparatus.

9. The image forming apparatus according to claim 1, further comprising:
an erasing unit, erasing said identification data and said user information stored in said storage unit, based either on elapsed time from printing or stored data capacity.

10. The image forming apparatus according to claim 1, wherein said generation unit generates said identification data from said image data, using a one-way function.

11. The image forming apparatus according to claim 10, wherein
said one-way function is a hash function.

12. An image processing terminal used in an image forming system in which an image data to be printed from an image processing terminal is transmitted to and printed by any of a plurality of image forming apparatuses connected by a network, comprising:
a transmitting unit transmitting, to said image forming apparatus, said image data and user information identifying a user who requested printing of said image data;
a receiving unit receiving alarm information transmitted from said image forming apparatus if it is determined, based on data synchronized among said plurality of image forming apparatuses, that an image corresponding to image data transmitted from said image processing terminal has already been printed by any of said plurality of image forming apparatuses; and
an output unit outputting said alarm information.

13. The image processing terminal according to claim 12, wherein
said alarm information indicates that the image data has already been printed by a user belonging to a group same as the user who requested printing of said image data, by any of said image forming apparatuses.

14. The image processing terminal according to claim 12, further comprising:
a setting unit setting that output of said alarm information is unnecessary, in correspondence with the user and identification data; and
a continuation request transmitting unit transmitting, if an object of said alarm information satisfies set conditions, a request to continue printing to said image forming apparatus without outputting said alarm information.

15. An image forming system including a plurality of image forming apparatuses according to claim 1 and at least one image processing terminal according to claim 12.
